(19) United States
(12) Patent Application Publication
(10) Pub. No.: US 2014/0320433 A1
(43) Pub. Date: Oct. 30, 2014

(54) TOUCH OPERABLE INFORMATION PROCESSING APPARATUS

(71) Applicant: CASIO COMPUTER CO., LTD., Tokyo (JP)

(72) Inventor: Masanori ISHIHARA, Tokyo (JP)

(73) Assignee: CASIO COMPUTER CO., LTD., Tokyo (JP)

(21) Appl. No.: 14/253,500

(22) Filed: Apr. 15, 2014

(30) Foreign Application Priority Data
Apr. 26, 2013 (JP) 2013-094259

(51) Int. Cl. G06F 3/041

(52) U.S. Cl. CPC G06F 3/0418; G06F 3/041
USPC 345/173

(57) ABSTRACT

The present invention includes: a detection function that detects a touch position on a touch screen; a selection function that selects a type of function using the touch screen; and a control function that changes a correction method of the touch position detected by the detection function according to the type of function selected by the selection function.

This application is based on and claims the benefit of priority from Japanese Patent Application No. 2013-094259, filed on 26 Apr. 2013, the content of which is incorporated herein by reference.

### BACKGROUND OF THE INVENTION

1. Field of the Invention

The present invention relates to an information processing apparatus, information processing method, and a program (storage medium).

2. Related Art

Demands for an information processing apparatus including a touch screen have increased recently (for example, refer to Japanese Unexamined Patent Application, Publication No. 2013-29971). An information processing apparatus realizes a predetermined function of application software and the like based on operations by a finger of a user or an object such as a stylus pen contacting a touch screen, i.e. a touch operation.

### SUMMARY OF THE INVENTION

One aspect of the present invention is an information processing apparatus including: a detection unit that detects a touch position on a touch screen; a selection unit that selects a type of function using the touch screen; and a control unit that changes a correction method of the touch position detected by the detection unit according to the type of function selected by the selection unit. Another aspect of the present invention is an information processing method including: detecting a touch position on a touch screen; selecting a type of function using the touch screen; and changing a correction method of the touch position detected by the detection unit according to the type of function selected by the selection unit.

Another aspect of the present invention is a non-transitory storage medium encoded with a computer-readable program that enables a computer to execute functions as: a detection unit that detects a touch position on a touch screen; a selection unit that selects a type of function using the touch screen; and a control unit that changes a correction method of the touch position detected by the detection unit according to the type of function selected by the selection unit.

### BRIEF DESCRIPTION OF THE DRAWINGS

FIG. 1 is a block diagram showing a hardware configuration of an image capture apparatus according to an embodiment of an information processing apparatus of the present invention;

FIG. 2 is a functional block diagram showing a functional configuration for executing image processing according to a touch operation among the functional configurations of the image capture apparatus of FIG. 1;

FIGS. 3A and 3B are views illustrating an example of a GUI image displayed when setting a function of a predetermined type;

FIG. 4 illustrates an example of a structure of a correction intensity table;

FIG. 5 shows another example of a structure of a correction intensity table, showing an example of a matrix structure; and

FIG. 6 is a flowchart illustrating a flow of image processing in response to a touch operation executed by the image capture apparatus 1 of FIG. 1 having the functional configuration of FIG. 2.

### DETAILED DESCRIPTION OF THE INVENTION

In the following, an embodiment of the present invention is described with reference to the drawings.

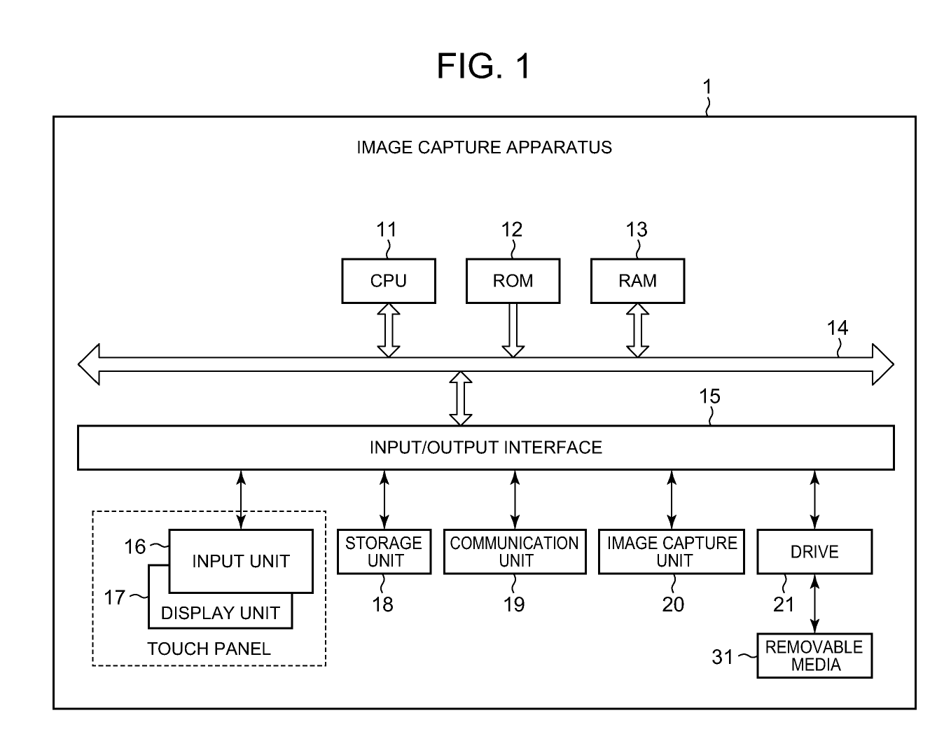

FIG. 1 is a block diagram showing a hardware configuration of an image capture apparatus according to an embodiment of an information processing apparatus of the present invention.

The image capture apparatus 1 is, for example, configured as a digital camera, and includes a CPU (Central Processing Unit) 11, ROM (Read Only Memory) 12, RAM (Random Access Memory) 13, a bus 14, an input/output interface 15, an input unit 16, a display unit 17, a storage unit 18, a communication unit 19, an image capture unit 20, and a drive 21.

The CPU 11 executes various processing according to programs that are recorded in the ROM 12, or programs that are loaded from the storage unit 18 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The input unit 16, the display unit 17, the storage unit 18, the communication unit 19, the image capture unit 20, and the drive 21 are connected to the input/output interface 15.

The input unit 16 is configured to include a capacitive or resistive position input sensor that is laminated on a display screen of the display unit 17. The position input sensor detects the coordinates of a position where a touch operation is performed. In this regard, the touch operation refers to an operation of touching or approaching an object (a finger or stylus of a user) on the input unit 16. It should be noted that hereinafter a position where a touch operation is made is referred to as “touch position” and the coordinates of the touch position are referred to as “touch coordinates”.

The display unit 17 is configured by the display and displays an image.

In other words, in the present embodiment, a touch screen is configured with the input unit 16 and the display unit 17.

The storage unit 18 is configured by a hard disk, DRAM (Dynamic Random Access Memory) or the like, and stores data of various images.

The communication unit 19 controls communication with other devices (not shown) via networks including the Internet.

The image capture unit 20 captures a subject and supplies digital signals (image signals) of an image including a figure of the subject (hereinafter, referred to as “captured image”) to the CPU 11. Here, the digital signals (image signals) of a captured image are referred to as “data of a captured image” as appropriate.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 18, as necessary. Similarly to the storage unit 18, the removable medium 31 can also store a variety of data such as the image data stored in the storage unit 18.

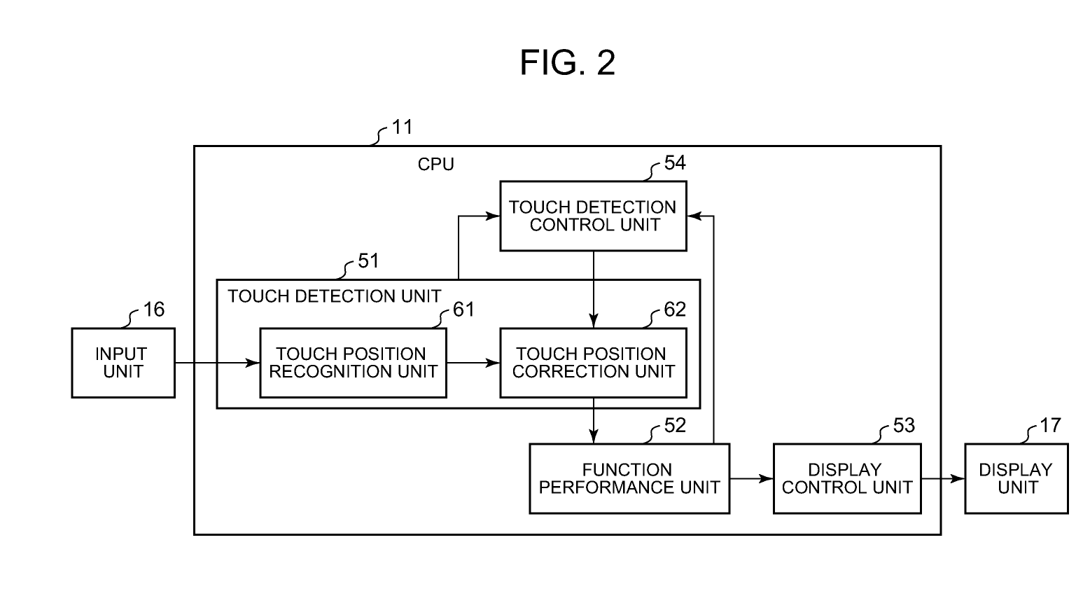

FIG. 2 is a functional block diagram showing a functional configuration for executing image processing in response to a touch operation among the functional configurations of the image capture apparatus 1.

The image processing in response to a touch operation refers to a sequence of processing of replaying or recording an image relating to a function upon the function using the touch screen being exhibited according to a touch operation.

When the image processing in response to the touch operation is performed, as shown in FIG. 2, a touch detection unit 51, a function performance unit 52, a display control unit 53, and a touch detection control unit 54 function in the CPU 11.

The touch detection unit 51 includes a touch position recognition unit 61 and a touch position correction unit 62 for the purpose of detecting touch coordinates.

The touch position recognition unit 61 recognizes touch coordinates when a touch operation is performed on a touch screen (more specifically, the input unit 16).

The touch position correction unit 62 corrects touch coordinates according to a predetermined method. Although the method to correct touch coordinates is not particularly limited, a method is employed in the present embodiment which corrects a touch position based on the results of detecting the touch position a plurality of times by the touch position recognition unit 61, i.e. a method of correcting a touch position by averaging a plurality of touch coordinates acquired by detecting the touch position a plurality of times.

The function performance unit 52 selects a type of function using the touch screen, performs a function of the type thus selected, and, based on touch coordinates detected by the touch detection unit 51, executes various processing related to the function of the predetermined type.

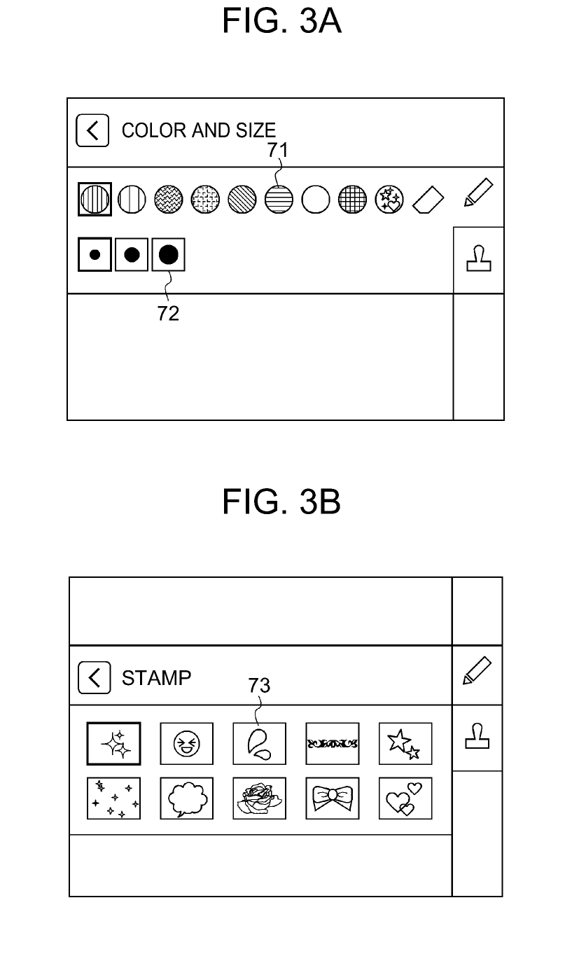

The display control unit 53 executes control to cause various images relating to a function of a type performed by the function performance unit 52, i.e. an image for setting of predetermined types of functions as shown in FIG. 3, for example, to display on the display unit 17.

FIG. 3 illustrates an example of a GUI (Graphical User Interface) image displayed upon setting a predetermined type of a function.

FIG. 3A illustrates a GUI image for setting a function of drawing a line at a touch position (hereinafter, referred to as “pen function”) and illustrates an example of a GUI image for setting the color and size of a line.

FIG. 3B illustrates an image for setting a function of combining a stamp at a touch position (hereinafter, referred to as “stamp function”) and illustrates an example of a GUI image for setting a stamp to be combined.

For example, when a user uses the pen function, it is possible to select a desired color for a line color by performing a touch operation on an icon of a desired color from among a plurality of icons 71 for selecting a line color in a state in which the GUI image of FIG. 3A is displayed on the display unit 17 of the touch screen.

Furthermore, for example, when the user uses the pen function, it is possible to select a desired size as a line size by performing a touch operation on an icon of a desired size from among a plurality of icons 72 for selecting a line size in a state in which a GUI image of FIG. 3A is displayed on the display unit 17 of the touch screen.

Furthermore, for example, when the user uses the stamp function, it is possible to select a desired stamp by performing a touch operation on a desired stamp from among a plurality of icons 73 for stamp selection in a state in which the GUI image of FIG. 3B is displayed on the display unit 17 of the touch screen.

With reference to FIG. 2 again, while a function of the type selected by the function performance unit 52 is executed, the touch detection control unit 54 controls to cause the touch detection unit 51 to perform a detecting operation of a touch position using a detecting method of the touch position selected according to the type of the function being executed.

Furthermore, the touch detection control unit 54 detects a physical touch condition that affects detection accuracy of a touch position on the touch screen. Then, the touch detection control unit 54 executes control for changing a detecting method of a touch position on a touch screen according to a type of a function using the touch screen and a difference in a physical touch condition affecting the detection accuracy of a touch position on the touch screen.

Here, a method of changing a detecting method of a touch position on a touch screen is not particularly limited. However, in the present embodiment, a method of changing from one pattern to another pattern among a plurality of patterns of detecting methods between which at least one of detection accuracy and detection speed is different is employed.

More specifically, in the present embodiment, the touch detection control unit 54 distinguishes a setting state of a function in the image capture apparatus 1, judges whether to correct touch coordinates acquired from the touch screen, and, in a case of correcting the touch coordinates, changes a setting of correction intensity.

Here, the correction of a touch position, as described above, is performed by averaging a plurality of touch coordinates acquired by detecting the touch position a plurality of times by way of the touch position correction unit 62. The number of detections of touch positions used for this averaging (hereinafter, referred to as “buffering number”) differs depending on the correction intensity.

It is configured in the present embodiment so that the correction intensity becomes greater with larger buffering number. More specifically, it is configured in the present embodiment so that the correction intensity (buffering number) is classified into five stages and the greatest correction intensity (buffering number) is “5” and the weakest correction intensity is “1”. It should be noted that the buffering number being “0” means that the correction is “OFF”.

In other words, making the correction intensity greater to make the buffering number greater means enhancing detection accuracy of the touch position. On the other hand, making the correction intensity degree weaker to make the buffering number less means enhancing the detection speed of the touch position.

It should be noted that, although it is configured to select a plurality of different detecting methods of the correction intensity (buffering number) as the method of changing the detection accuracy and detection speed in the present embodiment, it may be configured to change the type of correction method. For example, it may be configured such that: a method of not simply averaging a plurality of touch coordinates but averaging a plurality of touch coordinates after discarding coordinates deviating from Nσ of a normal distribution from among the plurality of touch coordinates as described above; a method of adopting the greatest/the least positional information, or positional information acquired at the earliest period/the latest period after discarding coordinates deviating from Nσ of a normal distribution from among the plurality of touch coordinates; or a method of converting to a median value of a plurality of touch coordinates by way of a median filter, can be selected.

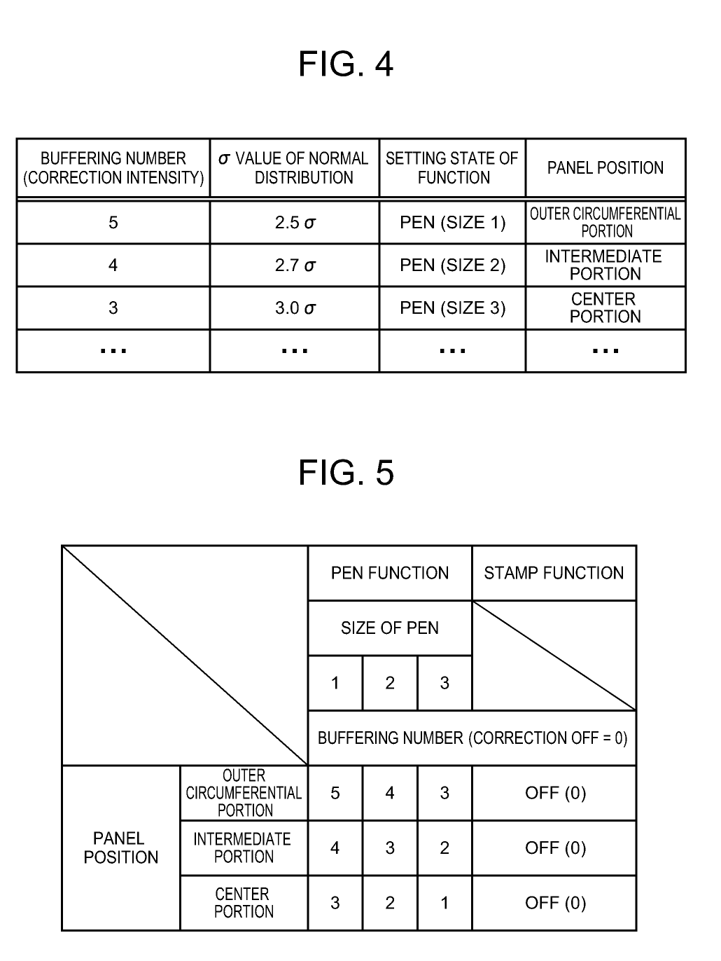

More specifically, in the present embodiment, with reference to the table of FIG. 4 or the matrix table of FIG. 5, the touch detection control unit 54 performs checking whether to perform correction or not and, in a case of performing correction, performs setting of correction intensity. It should be noted that the tables of FIGS. 4 and 5 are hereinafter collectively referred to as “correction intensity tables”.

FIG. 4 illustrates an example of a structure of a correction intensity table.

FIG. 5 is another example of a structure of a correction intensity table and illustrates an example of a matrix structure.

In the present embodiment, as shown in FIG. 4 or 5, when the stamp function is set, the correction is set to be “OFF” and when the pen function is set, the correction is set to be “present”.

Then, when the pen function is set, the correction intensity is variably set depending on the size of a line (the size of a pen). Here, it is configured in the present embodiment so that the size of a line (the size of a pen) is classified into three stages, the finest size being “1” and the largest size being “3”.

It is configured in the present embodiment so that the correction intensity becomes weaker as the size of a line (the size of a pen) becomes larger. This is because, as the size of a line (the size of a pen) becomes larger, even if the movement of a touch operation (drag operation) becomes blurring more or less, the blur affects a drawn line less.

Furthermore, in the present embodiment, the correction intensity can be set variably according to not only a setting state of a function, but also a difference in the physical conditions of a touch affecting the detection accuracy of a touch position on the touch screen.

More specifically, for the difference of a physical touch condition affecting detection accuracy of a touch position on a touch screen, a difference of an area where a touch is performed on a touch screen (hereinafter, referred to as “touch area”) is employed.

In the present embodiment, for the touch area, it is configured so that a screen position (a position on the screen of the display unit 17) is classified into three areas of “outer circumferential portion”, “intermediate portion”, and “center portion” and the correction intensity becomes weaker toward the “center portion” from the “outer circumferential portion” with the identical size of pen. This is because there is generally a tendency for the detection accuracy of a touch position on the touch screen to be more demanded for the “outer circumferential portion” and the detection speed is more demanded rather than the detection accuracy for the “center portion”.

Here, the correction intensity table of FIG. 4 includes an item of “G value of normal distribution”.

In the present embodiment, the touch position correction unit 62 buffers with a buffering number according to the correction intensity and corrects touch coordinates by calculating a moving average after discarding coordinates deviating from Nσ of a normal distribution among touch coordinates by the buffering number. It should be noted that the number of touch coordinates for calculating the moving average may be a number calculated by subtracting the discarded number of touch coordinates from the buffering number thus set or may be another buffering number set (the number of an actual buffering number incremented by the discarded number of touch coordinates).

The Nσ and moving average number are set as setting values associated with the setting of correction intensity, and these setting value are stored in the item of “σ value of normal distribution”.

It should be noted that it may be interpreted as the touch detection control unit 54 including a plurality of touch position correction units of which the types of correction methods correcting a touch position are different for detecting the touch position.

In such a case, the touch detection control unit can select whether to prioritize the detection accuracy of a touch position or to prioritize the detection speed of a touch position by selectively executing the plurality of touch position correction units.

Here, the correction method by way of the plurality of touch position correction units includes a correction method of averaging a plurality of touch coordinates as-is and a correction method of averaging touch coordinates after discarding touch coordinates deviating from Nσ of a normal distribution among a plurality of touch coordinates.

Next, image processing in response to a touch operation executed by the image capture apparatus 1 having such a functional configuration is described.

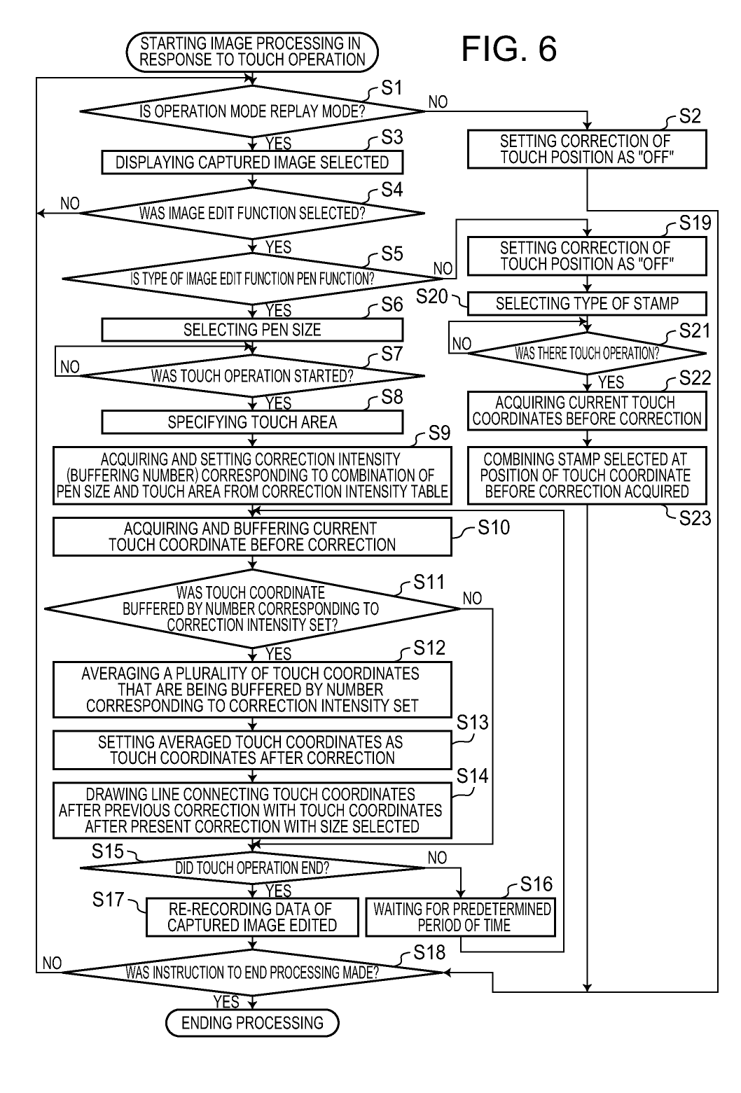

FIG. 6 is a flowchart illustrating an example of a flow of image processing in response to a touch operation executed by the image capture apparatus 1 of FIG. 1 having the functional configuration of FIG. 2.

When the image capture apparatus 1 is turned ON and a predetermined condition is satisfied, image processing in response to a touch operation starts and processing of the following Step S1 and higher is executed.

In Step S1, for example, the function performance unit 52 of FIG. 2 judges whether the operation mode of the image capture apparatus 1 is a replay mode.

In the present embodiment, for an operation mode of the image capture apparatus 1, a replay mode and a photography mode are provided, and in a case of the photography mode, it is judged as NO in Step S1 and the processing advances to Step S2.

In Step S2, the touch detection control unit 54 sets correction of touch position as “OFF”. It should be noted that, although “OFF” is employed for the correction of a touch position in the present example, the present invention is not limited thereto, and “present” may be employed for the correction of a touch position so long as it is independent from the replay mode. When the processing of Step S2 ends, the processing advances to Step S18. The processing of Step S18 and higher is described later.

On the other hand, in a case of the replay mode, it is judged as YES in Step S1, the processing advances to Step S3 and the following sequence of processing is executed.

In Step S3, the display control unit 53 displays a captured image selected on the display unit 17.

In Step S4, the touch detection control unit 54 judges whether an image edit function is selected.

In a case in which the image edit function is not selected, it is judged as NO in Step S4, the processing returns to Step S1 and the processing thereafter is executed repeatedly.

On the other hand, in a case in which the image edit function is selected, it is judged as YES in Step S4 and the processing advances to Step S5.

In Step S5, the touch detection control unit 54 judges whether the type of image edit function is a pen function.

In the present embodiment, as described above, the types of image edit function include the pen function (refer to FIG. 3A) and the stamp function (refer to FIG. 3B). In a case in which the type of image edit function is the stamp function, it is judged as NO in Step S5 and the processing advances to Step S19. The processing of Step S19 and higher is described later.

On the other hand, in a case in which the type of image edit function is the stamp function, it is judged as YES in Step S5, the processing advances to Step S6, and the following sequence of processing is executed.

In Step S6, the function performance unit 52 selects the size of a pen.

In other words, upon performing the pen function, the function performance unit 52 displays the GUI image of FIG. 3A on the display unit 17 for setting by way of the display control unit 53. A user viewing the GUI image performs a touch operation on an icon 72 of a desired size. The function performance unit 52 detects this touch operation via the touch detection unit 51 and selects a size corresponding to an icon 72 on which the touch operation is performed as the size of the pen.

In Step S7, the touch detection unit 51 judges whether a touch operation is started.

In a case in which a touch operation has not been started, it is judged as NO in Step S7 and the processing returns to Step S7. In other words, until a touch operation is started, the judging processing of Step S7 is executed repeatedly, whereby image processing in response to the touch operation enters an idle state.

When the touch operation is started, it is judged as YES in Step S7 and the processing advances to Step S8. In Step S8, the touch detection unit 51 specifies a touch area.

As described with reference to FIG. 3, in the present embodiment, as touch areas, screen position is classified into the three areas of “outer peripheral portion”, “intermediate portion”, and “center portion”. Therefore, in Step S8, any one among these three areas is specified as a touch area.

In Step S9, the touch detection control unit 54 acquires and sets a correction intensity (buffering number) corresponding to a combination of the size of the pen and the touch area from the correction intensity table. When a setting result is notified to the touch position correction unit 62, the processing advances to Step S10.

In Step S10, the touch position correction unit 62 acquires and buffers a current touch coordinate before correction.

In Step S11, the touch position correction unit 62 judges whether the touch coordinate is buffered by the number corresponding to the correction intensity thus set.

In a case in which the buffering number of the touch coordinates is less than the number corresponding to the correction intensity thus set, it is judged as NO in Step S11 and the processing advances to Step S15.

In Step S15, the touch detection unit 51 judges whether the touch operation ends (for example, whether a finger is released from the screen). In a case in which the touch operation continues, it is judged as NO in Step S15 and the processing advances to Step S16.

In Step S16, the touch detection unit 51 waits for a predetermined period of time. Here, the predetermined period of time should not be necessarily a fixed period of time, and may be a variable period of time which varies each time Step S16 is executed. Furthermore, the method of waiting is not particularly limited, and thus a method of setting the elapse of a predetermined period of time as a trigger may be employed or a method of setting a timing at which interruption of the CPU 11 occurs as the elapse of a predetermined period of time may be employed.

When the processing of Step S16 ends, the processing returns to Step S10 and further buffering of the touch coordinates is executed.

In other words, until the touch operation is over, loop processing of Steps S10, S11(NO), S15(NO), and S16 is executed repeatedly by the number corresponding to the correction intensity thus set and the touch coordinates are buffered by the number corresponding to the correction intensity thus set.

When the touch coordinates are buffered by the number corresponding to the correction intensity thus set, it is judged as YES in Step S11 and the processing advances to Step S12.

In Step S12, the touch position correction unit 62 averages a plurality of touch coordinates that are being buffered by the number corresponding to the correction intensity thus set.

In Step S13, the touch position correction unit 62 sets averaged touch coordinates as the touch coordinates after correction.

In Step S14, the function performance unit 52 draws a line connecting touch coordinates after a previous correction with touch coordinates after a present correction with a size selected. The display control unit 53 displays a line drawn at a corresponding position on the display unit 17. In such a case, the buffering number is re-set to be 0 (times) and the processing advances to Step S15.

In a case in which the touch operation continues, it is judged as NO in Step S15 and the processing advances to Step S16. In other words, while the touch operation continues, the loop processing of Steps S10 to S16 is executed, touch coordinates are corrected, and a line with touch coordinates after correction being an end point continues to be drawn while extending.

When the touch operation ends, it is judged as YES in Step S15 and the processing advances to Step S17.

In Step S17, the function performance unit 52 re-records data of a captured image edited.

In Step S18, the function performance unit 52 judges whether the instruction to end the processing was made. In a case in which an instruction to end the processing was not made, it is judged as NO in Step S18, the processing returns to Step S1 and the processing of Step S1 and higher is repeated.

On the other hand, in a case in which the instruction to end the processing was made, it is judged as YES in Step S18 and the overall image processing in response to the touch operation ends.

As described above, a sequence of processing in a case in which the pen function is selected as the image edit function is described.

Next, a sequence of processing in a case in which a stamp function is selected as an image edit function is described. In this case, it is judged as NO in Step S5 and the processing advances to Step S19.

In Step S19, the touch detection control unit 54 sets correction of a touch position as “OFF”. It should be noted that, although “OFF” is employed for the correction of a touch position in the present example, the present invention is not limited thereto, and “present” may be employed for the correction of a touch position so long as it is independent from the pen function.

In Step S20, the function performance unit 52 selects the type of stamp.

In other words, upon performing the stamp function, the function performance unit 52 displays the GUI image of FIG. 3B on the display unit 17 for setting by way of the display control unit 53. A user viewing the GUI image performs a touch operation on an icon 73 of a desired type. The function performance unit 52 detects this touch operation via the touch detection unit 51 and selects a size corresponding to the icon 73 on which the touch operation is performed as the type of stamp.

In Step S21, the touch detection unit 51 judges whether a touch operation is started.

In a case in which the touch operation has not been started, it is judged as NO in Step S21 and the processing returns to Step S21 again. In other words, until the touch operation is started, the judging processing of Step S21 is executed repeatedly, whereby image processing in response to the touch operation enters an idle state.

When the touch operation is started, it is judged as YES in Step S21 and the processing advances to Step S22.

In Step S22, the touch detection unit 51 acquires a current touch coordinate before correction.

In Step S23, the function performance unit 52 combines the stamp selected at a position of the touch coordinates before correction thus acquired. The display control unit 53 displays the stamp thus combined at a corresponding position of the display unit 17.

Then, the processing advances to Step S18 and the processing as described above is executed.

It should be noted that the present invention is not to be limited to the aforementioned embodiment, and that modifications, improvements, etc. within a scope that can achieve the object of the present invention are also included in the present invention.

In the abovementioned embodiment, although the type performed during the replay mode, i.e. the pen function and the stamp function are employed for the types of functions, the present invention is not limited thereto. For example, a function of a type performed upon the photography mode may be employed. More specifically, a function accompanied with a touch operation for performing various settings relating to photography, for example, a function accompanied with a step of specifying a subject by way of a touch operation, may be employed.

In the abovementioned embodiment, although the difference in area is employed for the difference in physical touch conditions, the present invention is not limited thereto and it is sufficient so long as it is a difference in physical touch conditions that affects the detection accuracy of a touch position on a touch screen.

More specifically, for example, a difference in physical touch conditions affecting the detection accuracy of a touch position may include a difference in temperature, humidity, atmospheric pressure, the ambient environment using another apparatus, aging degradation, a state of a screen, and the like. For example, since a difference in the state of a screen, such as a wet screen surface due to high humidity, affects touch conditions as well, the difference in touch conditions should include a difference in the state of a screen.

As described above, the image capture apparatus 1 as an information processing apparatus to which the present application is applied can include various embodiments having the following configuration as well as the abovementioned embodiments.

The image capture apparatus 1 includes the function performance unit 52 and the touch detection control unit 54.

The function performance unit 52 includes a selection unit that selects a type of a function using a touch screen.

The touch detection control unit 54 executes control to change a detection method of a touch position on the touch screen according to the type of function selected by the selection unit.

With such a configuration, it is possible to realize stable operation while executing the function thus selected.

The function performance unit 52 executes the function of the type thus selected.

The touch detection control unit 54 controls so as to perform a detecting operation of a touch position using a detecting method of the touch position selected according to the type of function being executed while a function of the type selected by the function performance unit 52 is executed.

With such a configuration, it is possible to realize a more stable operation while executing the function thus selected. In other words, Japanese Unexamined Patent Application, Publication No. 2013-29971 simply discloses selecting a detecting method of a touch position according to the type of function that is to be selected newly (a position of a menu area), but does not disclose a detecting method of a touch position while the function of a type that is already selected is executed. In this regard, in the present embodiment, since the abovementioned detecting method is employed as a detecting method of a touch position while a function of a type that is already selected, it is possible to realize a more stable operation while executing the function thus selected.

The touch detection control unit 54 further detects a physical touch condition that affects the detection accuracy of touch position on the touch screen. Then, the touch detection control unit 54 executes control to change a detecting method of a touch position on a touch screen according to the type of function selected by the function performance unit 52 and a touch condition detected.

With such a configuration, positional detection of a touch operation is performed appropriately and more stable operation is realized regardless of the setting state of a function or the state of a touch operation.

The touch detection control unit 54 can execute control to change from one pattern to another pattern among a plurality of patterns of detecting methods between which at least one of detection accuracy and detection speed is different.

With such a configuration, by appropriately controlling the trade-off relationship between the detection accuracy and the detection speed, more robust positional detection of a touch operation can be realized and more stable operation is realized.

The type of function using a touch screen includes a function of drawing a line at a touch position, and the touch detection control unit 54 can change the detecting method of a touch position between the function of drawing a line at a touch position and another function.

With such a configuration, in a case in which the function of drawing a line at a touch position is employed, positional detection of a touch operation can be performed appropriately and a more stable operation is realized.

In the type of the function of drawing a line at a touch position, the setting of selecting a size of a line is performed, and the touch detection control unit 54 can change the detecting method of a touch position for each setting which draws a different size of line at a touch position.

With such a configuration, in the function of drawing a line at a touch position, even in a case in which the size of line is arbitrarily set, positional detection of a touch operation is performed appropriately and more stable operation is realized.

The abovementioned other function includes a function of combining a stamp at a touch position.

With such a configuration, even in a case of selectively using a function of a drawing a line at a touch position (pen function) and a function of combining a stamp at a touch position (stamp function), positional detection of a touch operation is performed appropriately and more stable operation is realized.

It can be configured such that a difference in physical touch condition affecting the detection accuracy of a touch position includes a difference in the area in which a touch is performed on the touch screen.

With such a configuration, positional detection of a touch operation is performed appropriately according to the area in which a touch is performed on the touch screen and more stable operation is realized.

The difference in the physical touch condition affecting the detection accuracy of a touch position can include a difference in temperature, humidity, atmospheric pressure, the ambient environment using another apparatus, aging degradation, the state of the screen, and the like.

With such a configuration, as a difference in physical touch condition affecting the detection accuracy of a touch position, positional detection of a touch operation is performed appropriately according to various differences and more stable operation is realized.

The touch detection control unit 54 can select either one of a detecting method prioritizing the detection accuracy of a touch position or a detecting method prioritizing the detection speed of a touch position according to whether the function being executed prioritizes the detection accuracy of a touch position or prioritizes the detection speed.

With such a configuration, by appropriately controlling the trade-off relationship between the detection accuracy and the detection speed, more robust positional detection of a touch operation can be realized and more stable operation is realized.

The image capture apparatus 1 further includes the touch position correction unit 62 that corrects a touch position based on the results of detecting the touch position a plurality of times, as the detection of touch positions.

By changing the setting of correction intensity of these touch positions, the touch detection control unit 54 can select whether to prioritize the detection accuracy of the touch position or to prioritize the detection speed thereof.

By employing the correction intensity based on the number of detections of the touch positions, for example, since it becomes possible to configure a system more simply and appropriately control the trade-off relationship between the detection accuracy and the detection speed, more robust positional detection of a touch operation can be realized and more stable operation is realized.

The touch position correction unit 62 can correct a touch position by averaging a plurality of touch coordinates acquired by detecting the touch position a plurality of times.

With such a configuration, it becomes possible to correct a touch position more appropriately.

The touch position correction unit 62 further includes a plurality of touch position correction units, each correction unit having a different correcting method of correcting a touch position for which a type of correction method correcting a touch position differs therebetween, for detecting the touch position.

The touch detection control unit 54 selects whether to prioritize the detection accuracy of a touch position or prioritize the detection speed thereof by selectively executing the plurality of touch position correction units.

With such a configuration, by appropriately controlling the trade-off relationship between the detection accuracy and the detection speed, even more robust positional detection of a touch operation can be realized and more stable operation is realized.

The plurality of touch position correction units includes a correction method of averaging a plurality of touch coordinates as-is, and a correction method of averaging touch coordinates after discarding touch coordinates deviating from Nσ of a normal distribution among a plurality of touch coordinates.

With such a configuration, it becomes possible to correct a touch position more appropriately.

In the aforementioned embodiments, a smart phone has been described as an example of the information processing apparatus to which the present invention is applied; however, the present invention is not particularly limited thereto.

For example, the present invention can be applied to any electronic apparatus in general having a touch screen. More specifically, for example, the present invention can be applied to a lap-top personal computer, a printer, a television, a video camera, a portable navigation device, a cell phone device, a smart phone, a portable gaming device, and the like.

The processing sequence described above can be executed by hardware, and can also be executed by software.

In other words, the hardware configuration shown in FIG. 2 is merely an illustrative example, and the present invention is not particularly limited thereto. More specifically, the types of functional blocks employed to realize the above-described functions are not particularly limited to the example shown in FIG. 2, so long as the information processing apparatus 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, the ROM 12 shown in FIG. 1, a hard disk included in the storage unit 18 shown in FIG. 1 or the like, in which the program is recorded.

It should be noted that, in the present specification, the steps describing the program recorded in the storage medium include not only the processing executed in a time series following this order, but also processing executed in parallel or individually, which is not necessarily executed in a time series.

In addition, in the present specification, the term of system shall mean an entire apparatus configured from a plurality of devices, a plurality of means, and the like.

What is claimed is:

1. An information processing apparatus comprising:
a detection unit that detects a touch position on a touch screen;
a selection unit that selects a type of function using the touch screen; and
a control unit that changes a correction method of the touch position detected by the detection unit according to the type of function selected by the selection unit.

2. The information processing apparatus according to claim 1, further comprising:
an execution unit that executes the type of function selected by the selection unit,
wherein the control unit controls so as to perform a correcting operation of a touch position using the correction method of the touch position selected according to the type of the function being executed while the type of the function selected is executed by the execution unit.

3. The information processing apparatus according to claim 1, further comprising:
a condition detection unit that detects a physical touch condition affecting a detection accuracy of the touch position on the touch screen,
wherein the control unit changes the correction method of the touch position detected by the detection unit according to the type of function selected by the selection unit and the touch condition detected by the condition detection unit.

4. The information processing apparatus according to claim 1,
wherein the control unit changes from one correction method to another correction method among a plurality of correction methods between which at least one of the detection accuracy and the detection speed is different.

5. The information processing apparatus according to claim 1,
wherein the type of function using the touch screen includes a function of drawing a line at a touch position, and
wherein the control unit changes the correction method of the touch position between the function of drawing a line at a touch position and another function.

6. The information processing apparatus according to claim 5,
wherein, in the type of the function of drawing a line at a touch position, a setting of selecting a size of a line is performed, and
the control unit changes the correction method of the touch position for each setting which draws a different size of a line at the touch position.

7. The information processing apparatus according to claim 5, wherein the other function includes a function of combining a stamp at a touch position.

8. The information processing apparatus according to claim 1,
wherein a difference in a physical touch condition affecting the detection accuracy of the touch position includes a difference in an area in which a touch is performed on the touch screen.

9. The information processing apparatus according to claim 1,
wherein a difference in a physical touch condition affecting the detection accuracy of the touch position includes a difference in temperature, humidity, atmospheric pressure, the ambient environment using another apparatus, aging degradation, and state of a screen.

10. The information processing apparatus according to claim 4,
wherein the control unit selects either one of a detecting method prioritizing a detection accuracy of a touch position and a detecting method prioritizing a detection speed of a touch position, according to whether a function being executed prioritizes the detection accuracy of the touch position or prioritizes the detection speed thereof.

11. The information processing apparatus according to claim 4, further comprising:
a touch position correction unit that corrects a touch position based on detection results from detecting the touch position a plurality of times by the detection unit,
wherein, by changing a setting of correction intensity of the touch position, the control unit selects whether to prioritize the detection accuracy of the touch position or to prioritize the detection speed thereof.

12. The information processing apparatus according to claim 11,
wherein the touch position correction unit corrects a touch position by averaging a plurality of touch coordinates acquired by detecting the touch position a plurality of times.

13. The information processing apparatus according to claim 12, further comprising:
a plurality of touch position correction units, each correction unit having a different correcting method of correcting a touch position for which a type of correction method correcting a touch position differs therebetween,
wherein the control unit selects whether to prioritize the detection accuracy of a touch position or prioritize the detection speed thereof by selectively executing the plurality of touch position correction units.

14. The information processing apparatus according to claim 13,
wherein the plurality of touch position correction units includes a correction method of averaging a plurality of touch coordinates as-is and a correction method of averaging touch coordinates after discarding touch coordinates deviating from Nσ of a normal distribution among a plurality of touch coordinates.

15. An information processing method executed by an information processing apparatus, comprising:
detecting a touch position on a touch screen;
selecting a type of function using the touch screen; and
changing a correction method of the touch position detected by the detection unit according to the type of function selected by the selection unit.

16. A non-transitory storage medium encoded with a computer-readable program that enables a computer to execute functions as:
a detection unit that detects a touch position on a touch screen;
a selection unit that selects a type of function using the touch screen; and
a control unit that changes a correction method of the touch position detected by the detection unit according to the type of function selected by the selection unit.
